(19) United States
(12) Patent Application Publication
(10) Pub. No.: US 2007/0212037 A1
(43) Pub. Date: Sep. 13, 2007

(54) Heating element and mounting for media piping of fuel cell systems

(76) Inventors: Andreas Koenekamp, Darmstadt (DE); Dirk Wexel, Mainz (DE); Reiner Wilpsbaeumer, Wiesbaden (DE); Jurgen Thyroff, Harxheim (DE); Franz Winter, Mainz (DE)

Correspondence Address: CARY W. BROOKS;General Motors Corporation, Legal Staff, Mail Code 482-C23-B21, P.O. Box 300, Detroit, MI, 48265-3000, US

(21) Appl. No.: 11/368,059

(22) Filed: Mar. 3, 2006

(51) Int. Cl. F16L 53/00

(52) U.S. Cl. 392/468

(57) ABSTRACT

A heating system for a pipe or hose in a fuel cell system that include heaters and conductors to prevent water in the pipe or hose from freezing. A heater wire is provided in contact with the pipe, and a conductor is wrapped around the heater wire and the pipe, and a protective layer is wrapped around the conductor, where the conductor provides thermal isolation. For a plastic or rubber hose, an inner conductor is wrapped around the house and an outer conductor is wrapped around the inner conductor. Heater wire is positioned between the inner conductor and the outer conductor. A protective layer is then wrapped around the outer conductor.

### BACKGROUND OF THE INVENTION

1. Field of the Invention

This invention relates generally to specialized pipes and hoses for a fuel cell system and, more particularly, to specialized pipes and hoses for a fuel cell system that include heaters and conductors for preventing water in the pipes and hoses from freezing.

2. Discussion of the Related Art

Hydrogen is a very attractive fuel because it is clean and can be used to efficiently produce electricity in a fuel cell. A hydrogen fuel cell is an electro-chemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with the oxygen and the electrons in the cathode to generate water. The electrons from the anode cannot pass through the electrolyte, and thus are directed through a load to perform work before being sent to the cathode. The work acts to operate the vehicle.

Proton exchange membrane fuel cells (PEMFC) are a popular fuel cell for vehicles. The PEMFC generally includes a solid polymer-electrolyte proton-conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA).

Several fuel cells are typically combined in a fuel cell stack to generate the desired power. An automotive fuel cell stack may include about four hundred fuel cells to generate the desired power. The fuel cell stack receives a cathode reactant gas, typically a flow of air forced through the stack by a compressor. Not all of the oxygen is consumed by the stack and some of the air is output as a cathode exhaust gas that may include water as a stack by-product. The fuel cell stack also receives an anode hydrogen reactant gas that flows into the anode side of the stack.

The fuel cell stack includes a series of flow field or bipolar plates positioned between the several MEAs in the stack. The bipolar plates include an anode side and a cathode side for adjacent fuel cells in the stack. Anode gas flow channels are provided on the anode side of the bipolar plates that allow the anode gas to flow to the anode side of the MEA. Cathode gas flow channels are provided on the cathode side of the bipolar plates that allow the cathode gas to flow to the cathode side of the MEA. The bipolar plates also include flow channels through which a cooling fluid flows.

A fuel cell stack generates liquid and vaporized water by-product that is output at the outlet of the anode and cathode of the fuel cell stack. During a cold start of the fuel cell system, heat generated by the stack and released into the coolant is used to warm the fuel cell stack because of the heat capacity of the plate material and the coolant. As a result of this, the amount of emitted condensate and liquid water from the stack at start-up is higher than at low temperature starts. The liquid water has a tendency to freeze in low temperature environments that could affect the performance of the system, possibly catastrophically. Particularly, the frozen water could block pipes and hoses and could cause failures because of blocked gas delivery or pressure drop during start-up or operation of the fuel cell system. It is possible to provide larger diameter pipes and hoses. However, this is not always possible because of packaging or functional requirements.

For example, some fuel cell systems include an anode recirculation loop that recirculates un-reacted hydrogen gas from the exhaust of the anode back to the anode input. Because the anode exhaust gas is humidified, a water separator is sometimes provided in the anode re-circulation line to separate the water vapor therefrom, so that humidified anode exhaust does not cause water droplets when mixed with fresh anode hydrogen that could block the anode flow channels. The water separated from the anode exhaust is sent through a pipe or hose to a tank where it is accumulated. The tank includes a level indicator that indicates when the tank is full of water so that it can be vented without releasing hydrogen to the environment. Depending on the location of the tank, a pipe or hose may be provided between the tank and the location where the water is vented to the environment. Because the tank is only periodically vented, the hose between the water separator and the tank and the hose between the tank and the environment may have standing water in them, and this water may freeze in a cold environment. Other hoses and pipe in the fuel cell system, such as a hose to a pump that pumps the water from the water separator to the tank, may also include water or water vapor that could freeze in a cold environment.

It is known in the art to wrap a hose with a heater wire to prevent water in the hose from the freezing. However, such heater wires known in the art have been ineffective to sufficiently distribute the heat to the pipe or hose to prevent the water from freezing in fuel cell system hoses.

### SUMMARY OF THE INVENTION

In accordance with the teachings of the present invention, a heating system for a pipe or hose in a fuel cell system is disclosed that includes heaters and conductors to prevent water in the pipe or hose from freezing. In one embodiment, the pipe is a steel or metal pipe and a heater wire is provided in contact with the pipe. A heat conductor is wrapped around the heater wire and the pipe and a protective layer is wrapped around the heat conductor, where the heat conductor provides thermal isolation. The wire can either extend the length of the pipe or be wrapped around the pipe in a helical manner at a suitable pitch.

In an alternate embodiment for a plastic or rubber hose, an inner heat conductor is wrapped around the hose and an outer heat conductor is wrapped around the inner heat conductor. A heater wire is positioned between the inner heat conductor and the outer heat conductor. A protective layer is then wrapped around the outer heat conductor. The heat conductors can be any suitable heat conductor, such as a wire mesh tube or aluminum tape.

Additional features of the present invention will become apparent from the following description and appended claims, taken in conjunction with the accompanying drawings.

### BRIEF DESCRIPTION OF THE DRAWINGS

FIG. 1 is a cross-sectional view of a metal pipe including a heater wire and a conductor, according to an embodiment of the present invention;

FIG. 2 is a cross-sectional view of a plastic or rubber hose including an inner conductor, a heater wire and an outer conductor, according to another embodiment of the present invention;

FIG. 3 is a side view of a pipe or hose wrapped with a heater wire; and

FIG. 4 is a side view of a pipe or hose including two longitudinally extending heater wires.

### DETAILED DESCRIPTION OF THE EMBODIMENTS

The following discussion of the embodiments of the invention directed to a heating system for a pipe or hose in a fuel cell system is merely exemplary in nature, and is in no way intended to limit the invention or its applications or uses.

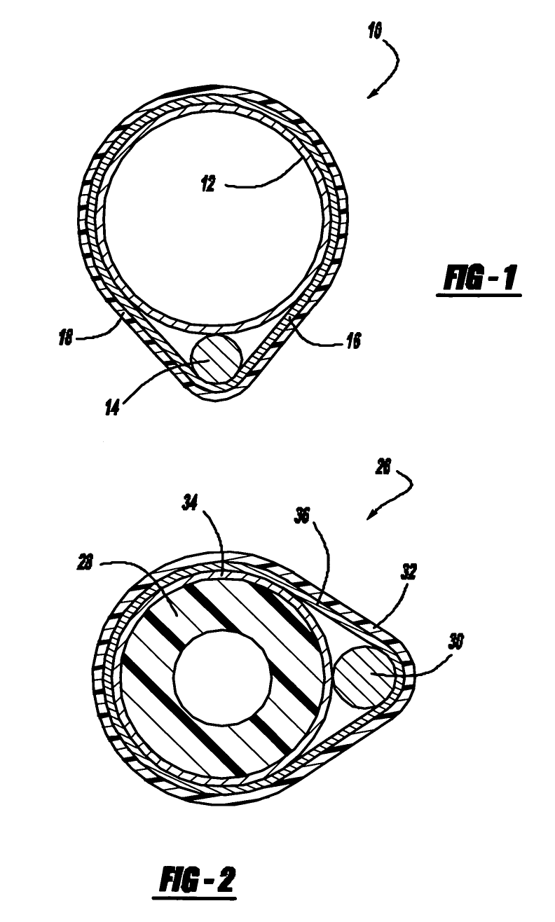

FIG. 1 is a cross-sectional view of a pipe system 10 including a steel or metal pipe 12. The pipe system 10 can be used for any suitable application in a fuel cell system, including, but not limited to, the pipe between a water separator and a water accumulation tank, and the pipe between the accumulation tank and a drain. According to the invention, the pipe system 10 includes a heater wire 14 that runs the length, or approximate length, of the pipe 12 and is positioned against the pipe 12, as shown. The heater wire 14 is connected to a controllable current source (not shown) to provide resistive heating so that heat therefrom is transferred to the heat conductor pipe 12. Therefore, any water in the pipe 12 is prevented from freezing.

According to the invention, the pipe system 10 includes a heat conductor 16 that is wrapped around the heater wire 14 and the pipe 12, as shown. A heat shrinkable protective layer 18, such as a suitable plastic, is wrapped around the conductor 16 to protect the pipe system 10, and provide thermal insulation. The conductor 16 provides a heat isolation barrier to reduce thermal losses to the environment. Also, the conductor 16 distributes the heat from the heater wire 14 so that the heater wire 14 does not damage and possibly affect the thermal properties of the protective layer 18.

FIG. 2 is a cross-sectional view of a hose system 26 including a plastic or rubber hose 28 that can also be used at various locations in the fuel cell system. The hose system 26 also includes a longitudinally extended heater wire 30 and an outer protective layer 32. In this embodiment, the hose system 26 includes an inner heat conductor 34 that is wrapped around the hose 28 between the hose 28 and the heater wire 30. The inner heat conductor 30 distributes the heat from the heater wire 30 to all surfaces of the hose 28 to provide more effective heating of the hose 28. An outer heat conductor 36 is wrapped around the heater wire 30 and the inner heat conductor 34, and provides thermal isolation and protection of the protective layer 32 as discussed above for the heat conductor 16.

The heat conductors 16, 34 and 36 can be any suitable heat conductor for the purposes described herein. Particularly, the heat conductors 16, 34 and 36 can have any suitable thickness and be made of any suitable heat conducting material for the purposes described herein. In one embodiment, the heat conductors 16, 34 and 36 are a mesh tube including an inner nylon support and an outer metal layer, such as nickel or silver. One suitable mesh tube for this purpose is a known mesh that provides electro-magnetic protection. A suitable diameter mesh tube is provided for the particular hose or pipe system to be heated. By pushing on the ends of the mesh tube, the diameter of the mesh tube will increase allowing the pipe to be slid into the mesh tube to provide the heat conductor 16, 34 and 36. By pulling on the ends of the mesh tube, the mesh tube will tighten on the particular hose or pipe. Alternatively, the heat conductors 16, 34 and 36 can be a self-adhesive aluminum tape that is adhered to the particular pipe or hose. The self-adhesive aluminum tape conductor has particular application where electrical connectors and the like prevent the mesh tube from being inserted over the pipe or hose. However, as will be appreciated by those skilled in the art, other conductors can also be used consistent with the discussion herein.

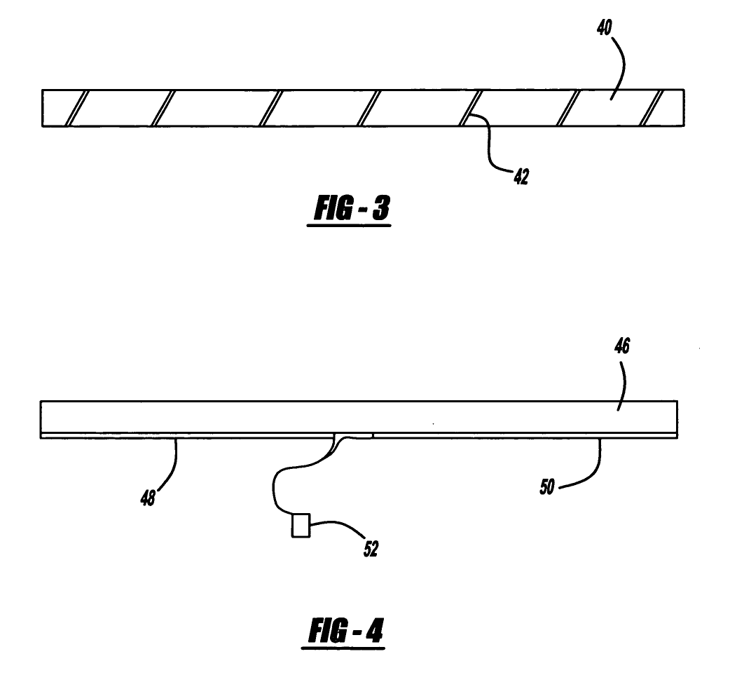

The systems 10 and 26 discussed above have the wires 14 and 30 that extend the length of the pipe 12 and the rubber hose 26, respectively. In an alternate embodiment, it may be necessary to provide additional heating by wrapping the heater wire around the pipe or hose at a certain pitch. FIG. 3 is a length-wise view of a pipe or hose 40 including a heater wire 42 wrapped in a helical manner around the pipe 40 to illustrate this embodiment. The inner and/or outer conductors are not shown in this figure.

The heater wires 14 and 30 can be a single length heater wire extending the length of the pipe or hose, or can be separated heater wires having two connectors. FIG. 4 is a length-wise view of a pipe or hose 46 including two length-wise heater wires 48 and 50 that combine to cover the extended length of the hose 46. The two wires 48 and 50 are connected to an electrical connector 52 that provides electrical coupling to the wire 48 and 50.

Practical applications for the wire heating system of the invention are application specific. For fuel cell applications, heating power of up to 15 W/m or 20 mm diameter wires may be necessary to prevent freezing in the pipe or hose. Alternately, 50 W/m of heater power may be required for a 20 mm diameter pipe or hose to thaw already frozen water. The maximum heater temperature should not exceed the maximum temperature capability of the heated component. The heater wire material can be any suitable resistive heater material, such as positive temperature coefficient (PTC) or negative temperature coefficient (NTC) heater material with wire insulation. Also, heater power can be controlled depending on the ambient temperature around the vehicle by switching the heater wire on and off. Further, switching on the heater wire can be accomplished by temperature sensors and controls or by a thermal switch to prevent heating at temperatures where it is not needed.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A tube heater system comprising:
an elongated tube;
a heater wire positioned proximate the tube;
a first heat conductor wrapped around the heater wire and the tube; and
a protective layer wrapped around the first heat conductor, wherein the first heat conductor provides thermal isolation and distributes heat to the protective layer.

2. The system according to claim 1 wherein the elongated tube is a metal pipe and the heater wire is positioned in contact with the metal pipe.

3. The system according to claim 1 further comprising a second heat conductor, wherein the elongated tube is a plastic or rubber tube, and wherein the second conductor is wrapped around the tube, the heater wire is positioned in contact with the second heat conductor, and the first heat conductor is wrapped around the heater wire and the second heat conductor.

4. The system according to claim 1 wherein the heater wire longitudinally extends the length of the elongated tube.

5. The system according to claim 1 wherein the heater wire is wrapped around the tube in a helical manner.

6. The system according to claim 1 wherein the first heat conductor is a mesh tube.

7. The system according to claim 1 wherein the first heat conductor is an aluminum tape.

8. The system according to claim 1 wherein the protective layer is a heat shrinkable plastic layer.

9. The system according to claim 1 wherein the system is used in a fuel cell vehicle.

10. A hose system comprising:
an elongated hose;
an inner heat conductor wrapped around the hose;
a heater wire positioned in contact with the inner heat conductor;
an outer heat conductor wrapped around the heater wire and the inner heater conductor; and
a protective layer wrapped around the outer heat conductor, wherein the inner heat conductor distributes heat from the heater wire to the hose and the outer heat conductor provides thermal isolation and distributes heat to the protective layer.

11. The system according to claim 10 wherein the heater wire longitudinally extends the length of the hose.

12. The system according to claim 10 wherein the heater wire is wrapped around the heater conductor in a helical manner.

13. The system according to claim 10 wherein the inner heat conductor and the outer heat conductor are a mesh tube.

14. The system according to claim 10 wherein the inner heat conductor and the outer heat conductor are aluminum tape.

15. The system according to claim 10 wherein the protective layer is a heat shrinkable plastic layer.

16. A pipe system comprising:
a metal pipe;
a heater wire positioned in contact with the pipe;
a heat conductor wrapped around the heater wire and the pipe; and
a protective layer wrapped around the heat conductor, wherein the heat conductor provides thermal isolation and distributes heat to the protective layer.

17. The system according to claim 16 wherein the heater wire longitudinally extends the length of the hose.

18. The system according to claim 16 wherein the heater wire is wrapped around the heater conductor in a helical manner.

19. The system according to claim 16 wherein the heat conductor is a mesh tube.

20. The system according to claim 16 wherein the heat conductor is an aluminum tape.

21. The system according to claim 16 wherein the protective layer is a heat shrinkable plastic layer.
